(19) United States
(12) Patent Application Publication
(10) Pub. No.: US 2016/0146238 A1
(43) Pub. Date: May 26, 2016

(54) Device for Connecting Profile Elements

(71) Applicant: Liebherr-Werk Biberach GmbH, Biberach an der Riss (DE)

(72) Inventors: Jacek KRUPINSKI, Trier (DE); Norbert STANGER, Attenweiler (DE)

(21) Appl. No.: 14/896,280

(22) PCT Filed: May 13, 2014
(86) PCT No.: PCT/EP2014/001292

§ 371 Date: Dec. 4, 2015

(30) Foreign Application Priority Data
Jun. 6, 2013 (DE) 10 2013 009 564.6

(51) Int. Cl. F16B 7/04

(52) U.S. Cl. CPC F16B 7/0413

(57) ABSTRACT

The present invention relates to a mechanism for connecting profile elements and corresponding uses of the mechanism wherein the mechanism is provided with at least two mutually connected sheet metal plates combined to form a stack of sheet metal plates, with mutually aligned apertures and at least two bolts, and wherein the stack can be inserted between two profile elements to be connected and is preferably releasably connected by means of the at least two bolts.

The present invention relates to a mechanism for connecting profile elements and to appropriate applications of the mechanism.

In connecting profile elements, it is known to use as a connecting element a homogenous component with a strength comparable to the material of the connected elements themselves and to insert it between these to produce a connection between the two profile elements. Typically, for example for a crane, two belt elements of sheet metal can be held together by a connecting element also made of sheet metal.

One problem that can arise is that to give the connection between the profile elements sufficient strength, a connecting element of a disadvantageously large size has to be provided, which has a directly disadvantageous effect on the size of the profile elements to be connected. Its size has to be large enough to accommodate the connecting element.

It is therefore the object of the present invention to provide a mechanism for connecting profile elements which advantageously extends the known mechanisms, in particular in terms of the strength of the connection of the profile elements.

According to the invention, this object is achieved by a mechanism with the characteristics of claim 1, namely a mechanism to connect profile elements, in particular sheet metal elements, wherein the mechanism has at least two sheet metal plates combined into a stack of sheet metal plates with mutually aligned apertures and at least two bolts, and wherein the stack of sheet metal plates can be inserted between two profile elements to be connected and is preferably releasably connectable with these by means of the at least two bolts.

Using a stack of sheet metal plates as a connecting element possibly made of various sheet metal plates advantageously allows greater flexibility for the design of the connecting element in terms of its dimensions and choice of material.

In a preferred embodiment it is conceivable that the sheet metal plates are made of high-strength steel. For example, the sheet metal plates can be produced in a stamping process that is superior to customary production processes such as machining processes, in terms of the tolerances that can be reached and in terms of the material strength.

In another preferred embodiment it is also conceivable that the sheet metal plates are cemented and/or riveted together. In that way it can be assured that the sheet metal plates, which have a force-transmitting function in connection with the profile elements, are as evenly resilient as possible, such that there is the least possible imbalance in the load bearing capacity of each sheet metal plate.

In a particularly preferred embodiment, it is also conceivable that the sheet metal plates are provided with rivet holes for rivets by which the sheet metal plates are connected with each other. Sheet metal plates with correspondingly provided rivet holes allow the advantageous production of the stacks of sheet metal plates. For example, the rivet holes can be inserted in the sheet metal plates in the stamping process by which the plates are made, which eliminates the need for any large-format riveting apparatus when the stacks of sheet metal plates are installed.

In another preferred embodiment, it is conceivable that the apertures for the bolts have various dimensions. For example, one configuration is simply accomplished in which the sheet metal plates farther inward in a stack have larger apertures for bolts than those farther outward. As will be shown below, this can be particularly advantageous when such a stack configuration is useful for achieving greater strength within the stack.

Another preferred embodiment can be configured such that the sheet metal plates have various and/or identical thicknesses. One such stack of sheet metal plates with plates of various thicknesses allows a construction in which the deformation of the bolts or their deflection line must be taken into account and to provide a stack where the individual sheet metal plates have zones with various strain characteristics. Advantageously this allows the sheet metal to be better utilized, and it provides a connecting element with a smaller surface.

Another preferred embodiment is conceivable in which at least one sleeve is provided inside the stack of sheet metal plates. Advantageously the sleeve can be designed to transfer the load between the stack and the bolt such that for example the stress on the individual sheet metal plates is as evenly distributed as possible.

In a particularly preferred embodiment it is conceivable that the at least one sleeve is stepped and a load can be applied to the various plates at different distances from a sleeve axis. That advantageously allows an even better distribution of the load among the individual sheet metal plates.

One embodiment is preferred where the sleeve is arranged mostly in a middle section of the stack. That way it is possible to utilize the special design of the stack such that the inside sleeve can advantageously be simply mounted inside the stack and locked there. For example, this may eliminate the need for a special arrangement to lock the sleeve.

The invention also relates to the use of a mechanism according to one of claims 1 to 9 for connecting two profile elements, especially two metal elements. Here and in the following embodiments the advantages of the invention named above become apparent.

In one preferred embodiment, it can also be provided that the profile elements are hollow elements.

In another preferred embodiment, it can be provided that the profile elements are components of a machine, preferably a construction machine and especially preferably a tower crane.

Furthermore the invention also relates to a machine, particularly a tower crane, wherein the tower and/or the jib of the tower crane comprises at least two belts which are connected by means of a mechanism according to one of claims 1 to 9.

Finally, the invention relates to a set consisting of the machine, at least two profile elements and at least one mechanism according to claims 1 to 9.

Further details and advantages of the invention are now explained in detail with reference to the embodiments shown in the figures, where

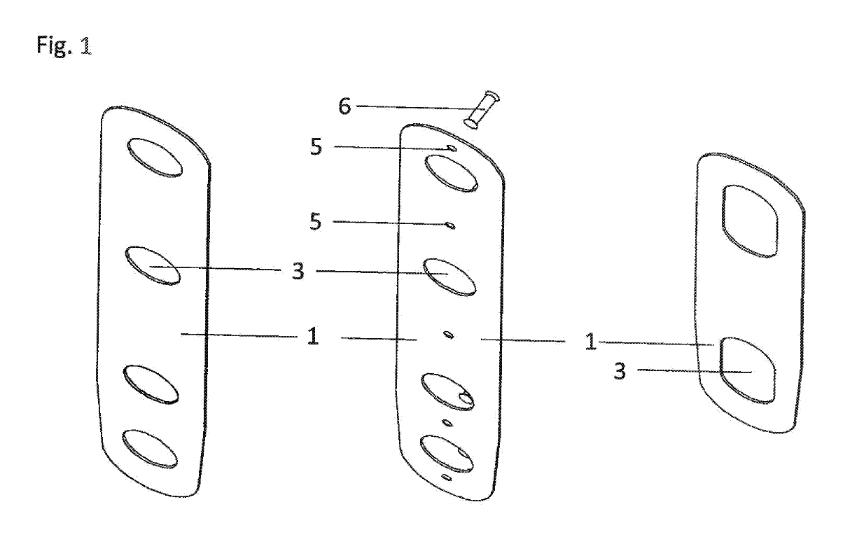

FIG. 1 shows various embodiments of sheet metal plates;

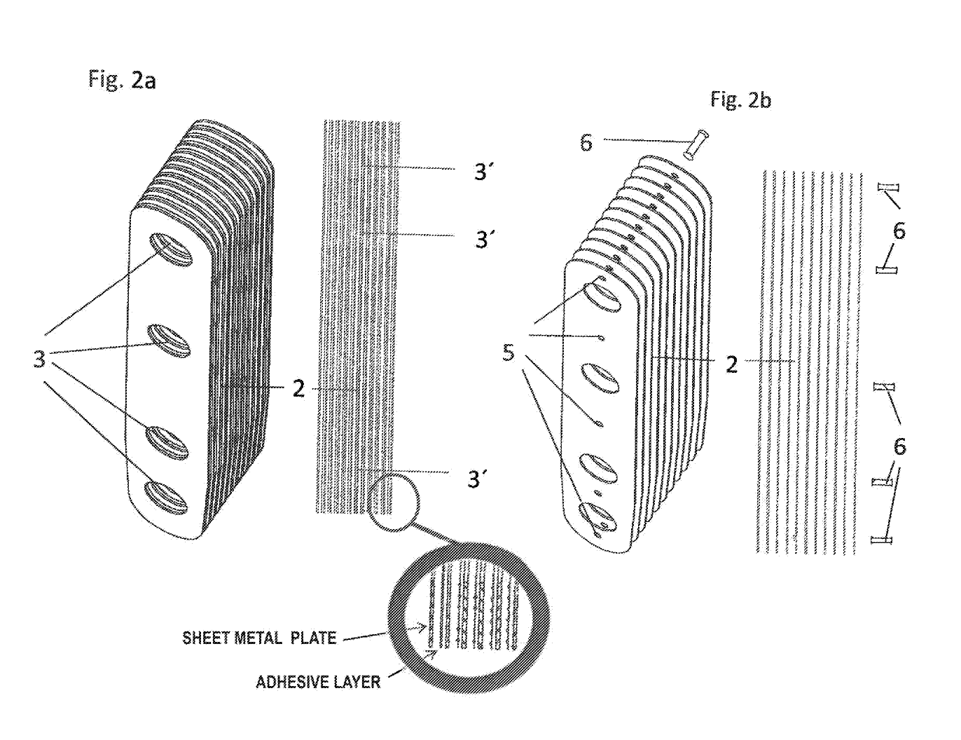

FIG. 2a shows a cemented stack of sheet metal plates;

FIG. 2 shows a riveted stack of sheet metal plates;

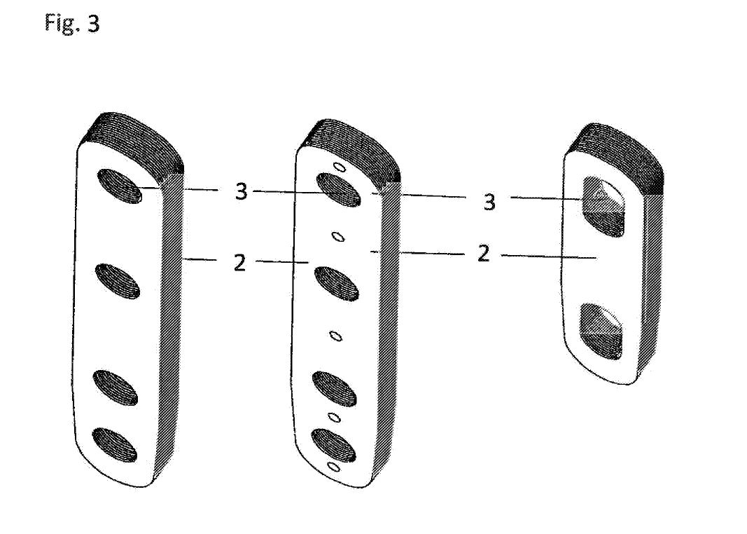

FIG. 3 shows a variety of stacks of sheet metal plates;

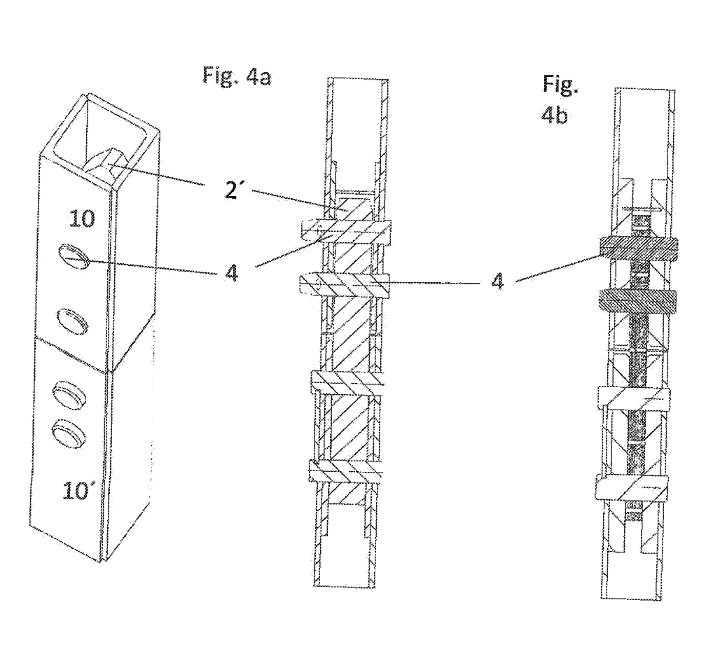

FIG. 4a shows a mechanism for connecting the profile elements according to the state of the art;

FIG. 4b shows an improved mechanism for connecting the profile elements;

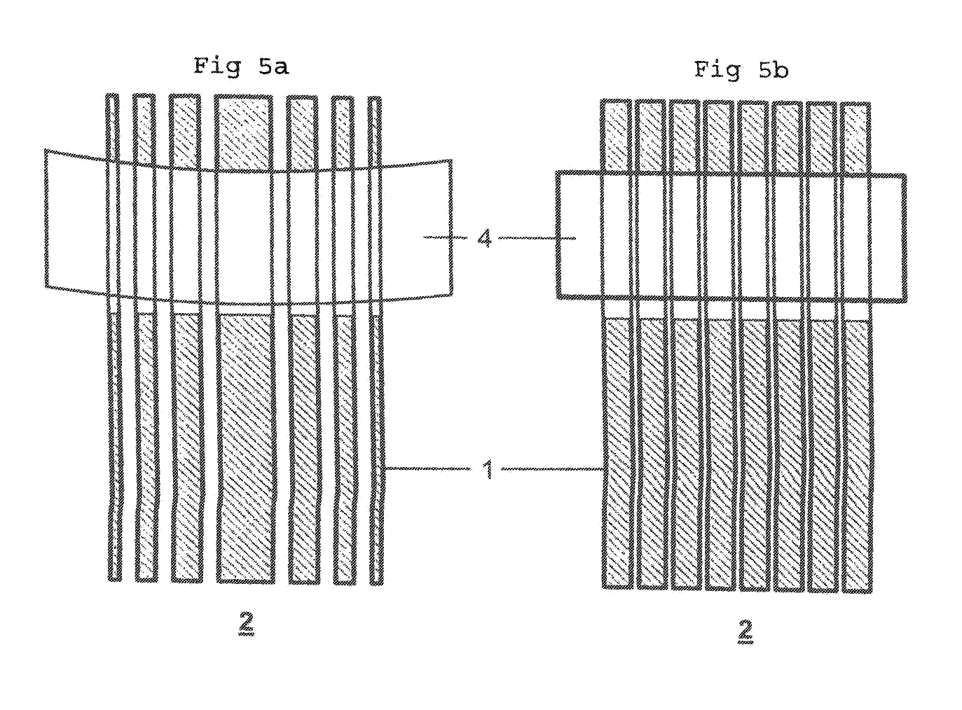

FIG. 5a, 5b show stacks of sheet metal plates of different thicknesses under stress and unstressed;

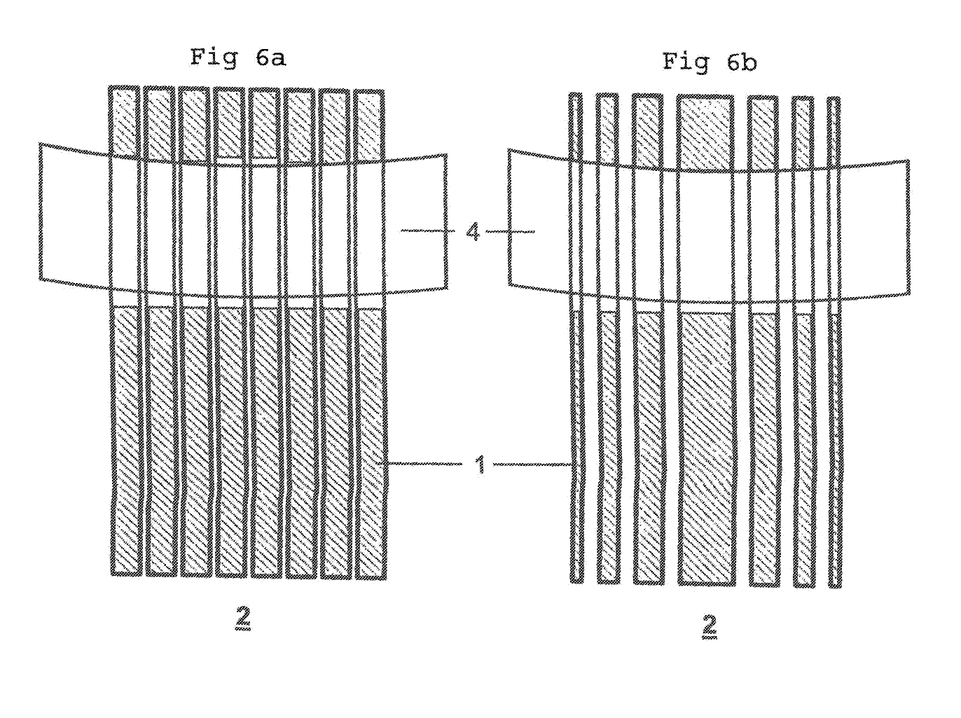

FIG. 6a, 6b show stacks of sheet metal plates of different and equal thicknesses under stress;

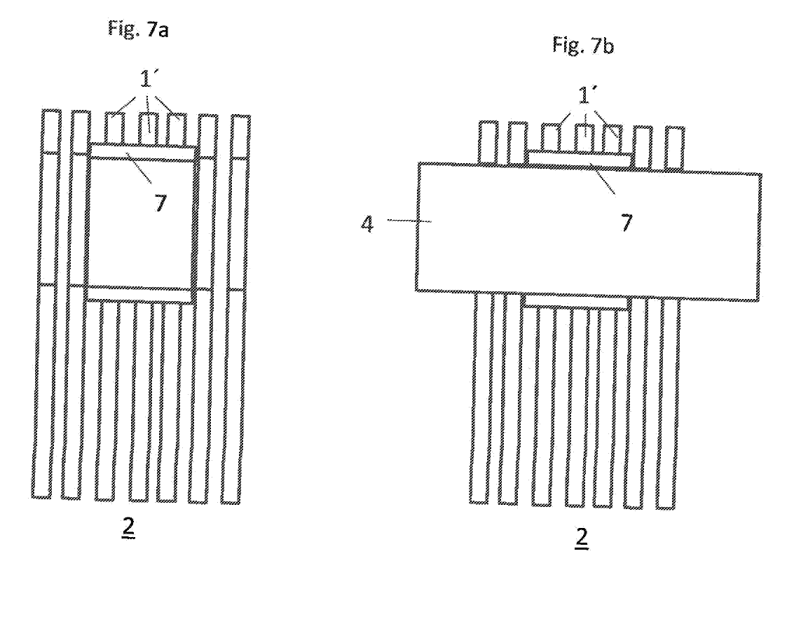

FIG. 7a, 7b show various combinations of stacks of sheet metal plates, sleeves and bolts;

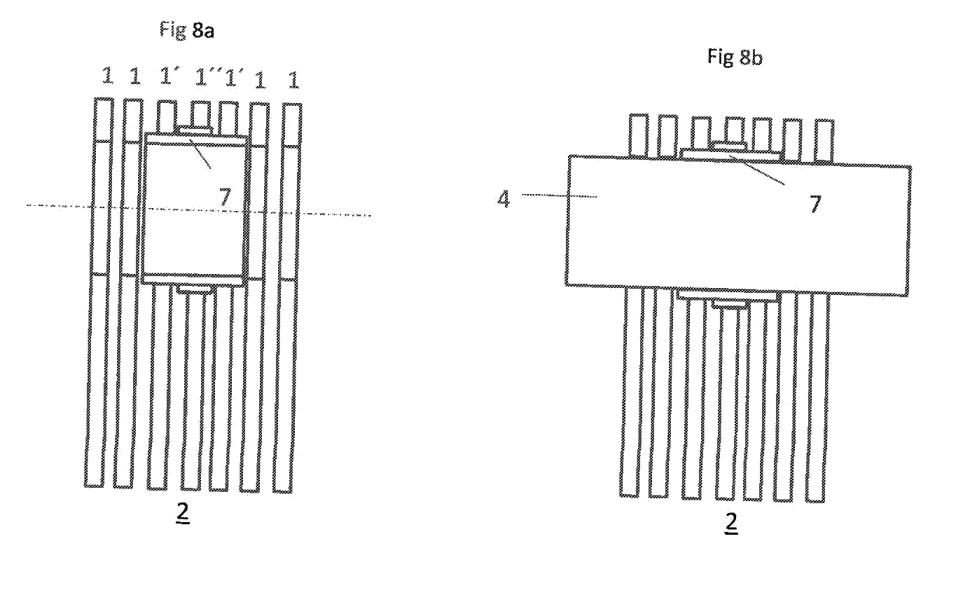

FIG. 8a, 8b show various combinations of stacks of sheet metal plates, stepped sleeves, and bolts;

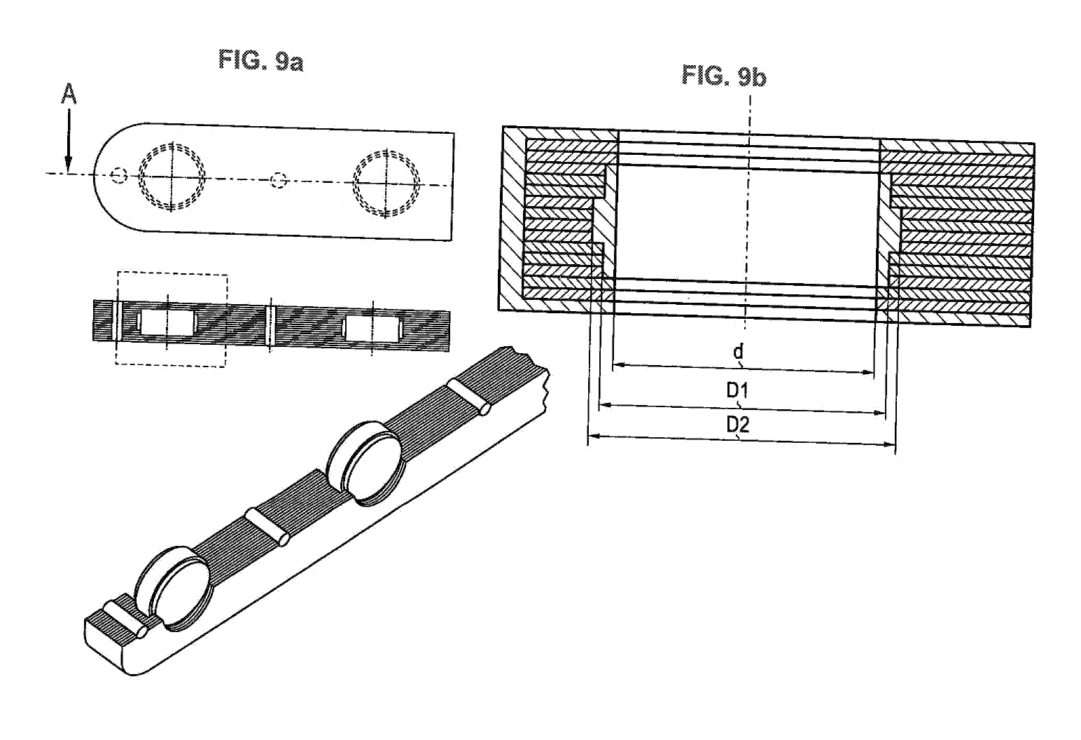

FIG. 9a, 9b show a more detailed view of the stacks of sheet metal plates shown in FIGS. 8a and 8b.

FIG. 1 shows examples of the embodiments of sheet metal plates 1. As shown, several similar or identical plates 1 can be combined to form a stack 2 of sheet metal plates. Shown are apertures 3 to accommodate bolts 4, and rivet holes 5 for rivets 6, with which several plates 1 can be connected as required. In general, apertures 3 can have different shapes. For example, cylindrical or elongates apertures are conceivable.

FIG. 2a shows an embodiment in which several sheet metal plates 1 are cemented to form a stack 2. Here, adhesive layers and sheet metal plates alternate, and the apertures 3 of the plates 1 are arranged such that the entire stack 2 has apertures consisting of the combined individual apertures 3.

FIG. 2b on the other hand shows a riveted stack 2 of sheet metal plates where in the embodiment shown five rivets 6 pass through corresponding rivet holes 5, thus holding together stack 2 without adhesion. However, a combination of cementing and riveting the stack 2 is also conceivable, as are other common methods of connection.

FIG. 3 shows various embodiments of stacks 2 of sheet metal plates which can be cemented or riveted and can have apertures 3 in a variety of geometric shapes.

FIG. 4a shows a mechanism for connecting profile elements according to the state of the art. Here, two profile elements 10 and 10′ are connected with other via a homogenous connecting element 2′ of steel and bolts 4. The strength of the connecting element 2′ is comparable to the strength of the two profile elements 10 and 10′.

FIG. 4b shows a mechanism according to the invention where due to the use of sheet metal plates 1 made of high-strength steel, which are stamped and stacked above each other by cementing or riveting to form stacks 2, a considerably smaller connecting element 2′ is provided which due to its greater material strength has the same strength as a connecting element 2′ according to the state of the art.

FIG. 5a shows that the sheet metal plates 1 can have different and/or equal thicknesses to be formed into a stack 2. This allows utilization of the various strain characteristics of the plates 1 with different thicknesses, in particular in the stressed state of bolt 4, to allow a better fit of bolt 4 to stack 2.

FIG. 5b shows a bolted stack 2 in an unstressed state.

FIGS. 6a and 6b clearly show the difference between a stack 2 with plates 1 of different thicknesses and a stack 2 with plates 1 of equal thicknesses. While in FIG. 6a the outer plates 1 are the farthest stretched plates 1 of stack 2, the connecting bolt 4 bends so far due to the tensile load in stack 2 that bolt 4 no longer applies a load to the middle plates 1 and bolt 4 is subjected to a curvature or bend X. This means that the outer plates 1 bear the main load of stack 2 and are thus most strongly stressed. This heterogenous stress of the plates 1 in stack 2 is a disadvantage because the outer plates 1 are subjected to a greater risk of breakage. To counter this, a stack 2 with plates 1 of different thicknesses is provided. The plates 1 in the middle of stack 2 have greater thicknesses and are attuned to the deflection line of bolt 4 such that the strain characteristic of plates 1 is the same as the deflection line of bolt 4, and bolt 4 is only bent to a curvature X1. It is thus prevented, as shown in FIG. 6a, that the plates 1 in the middle lose contact with bolt 4.

FIG. 7a shows an embodiment in which a sleeve 7 is inserted into apertures 3 or 3′. For that purpose, the inner plates 1′ are provided with larger apertures 3. If the plates 1 are combined into a stack 2, sleeve 7 is thus locked in stack 2. As shown in FIG. 7b, a bolt 4 can then be inserted through stack 2 and sleeve 7.

In an alternative embodiment it is conceivable that sleeve 7 is designed as a stepped sleeve 7, and for locking sleeve 7 in stack 2, plates 1 are provided with apertures 3 of variable diameters. As FIG. 8a shows, an innermost plate 1″ is provided with an aperture 3 with the largest diameter of all apertures 3 within stack 2. On the other hand, plates 1′ have an aperture 3 with a smaller diameter, and the remaining plates 1 have apertures with the smallest diameters within stack 2.

FIG. 8b as well as FIG. 8a show a stepped sleeve 7, but with a bolt 4 inserted therein. FIGS. 9a and 9b show a more detailed presentation of stacks 2 from FIGS. 8a and 8b, in a lateral view (9a) and a sectional view (9b).

1. A mechanism for connecting profile elements, comprising:
at least two sheet metal plates combined to form a stack of sheet metal plates with mutually aligned apertures, and
at least two bolts,
wherein the stack of sheet metal plates is insertable between two profile elements to be connected and connectable with the two profile elements via the at least two bolts.

2. The mechanism according to claim 1, wherein the plates are made of high-strength steel.

3. The mechanism according to claim 1, wherein the plates are cemented and/or riveted together.

4. The mechanism according to claim 1, wherein rivet holes for rivets are provided in the plates by way of which the plates are combined to form the stack.

5. The mechanism according to claim 4, wherein the apertures for the bolts have different sizes.

6. The mechanism according to claim 1, wherein the plates have different and/or equal thicknesses.

7. The mechanism according to claim 1, further comprising at least one sleeve provided within the stack.

8. The mechanism according to claim 7, wherein the at least one sleeve is stepped, and loads can be applied to different plates of the stack at different distances from a sleeve axis.

9. The mechanism according to claim 7, wherein the at least one sleeve is provided mainly in a middle section of the stack.

10. A process of connecting two metal profile elements comprising:
providing a mechanism for connecting the profile elements that includes at least two sheet metal plates, combined to form a stack of sheet metal plates with mutually aligned apertures, and at least two bolts,
inserting the stack of sheet metal plates between the two metal profile elements, and
connecting the metal two profile elements via the at least two bolts.

11. The process according to claim 10, wherein the profile elements are hollow profiles.

12. The process according to claim 10, wherein the profile elements are components of a machine.

13. A tower crane comprising at least two belts connected by the mechanism according to claim 1.

14. (canceled)

15. The mechanism according to claim 1, wherein the profile elements are metal profile elements.

16. The mechanism according to claim 1, wherein the stack of sheet metal plates is releasably connectable with the two profile elements.
